(19) United States
(12) Patent Application Publication
(10) Pub. No.: US 2008/0304106 A1
(43) Pub. Date: Dec. 11, 2008

(54) IMAGE PROCESSING APPARATUS, PRINTING APPARATUS, AND CONTROL PROGRAM

(76) Inventor: Kenji ITOH, Osaka (JP)

Correspondence Address: BIRCH STEWART KOLASCH & BIRCH, PO BOX 747, FALLS CHURCH, VA, 22040-0747, US

(21) Appl. No.: 12/134,070

(22) Filed: Jun. 5, 2008

(30) Foreign Application Priority Data
Jun. 6, 2007 (JP) 2007-150971

(51) Int. Cl. G06F 15/00; G09G 5/39

(52) U.S. Cl. 358/1.16; 345/531

(57) ABSTRACT

An image processing apparatus comprises a transfer processing section, a plurality of image processing sections, and a control section. The transfer processing section is for transferring image data to a memory. The image processing section is for carrying out an image process with respect to image data, and writing, into the memory, the image data that has been subjected to the image process. The control section is for controlling the transfer processing section and the plurality of image processing sections. The control section includes: a selecting section that selects two or more processing sections from among the transfer processing section and the plurality of image processing sections; and an initialization control section that causes the processing sections selected by the selecting section to carry out an initialization process with respect to the memory. This makes it possible to carry out an initialization process with respect to the memory at a high speed, without causing an increase in cost.

This Nonprovisional application claims priority under 35 U.S.C. §119(a) on Patent Application No. 150971/2007 filed in Japan on Jun. 6, 2007, the entire contents of which are hereby incorporated by reference.

### FIELD OF THE INVENTION

The present invention relates to an image processing apparatus which carries out various kinds of image processes with respect to image data loaded on a memory.

### BACKGROUND OF THE INVENTION

A printing apparatus such as a multifunction peripheral, a copying machine, a printer, or a facsimile includes a control device which controls operations of the entire printing apparatus. The control device includes a CPU, a page memory in which image data is temporarily stored for every page and an ASIC (Application Specific Integrated Circuit) which carries out an image process based on hardware with respect to image data stored in the page memory.

The ASIC is provided with a DMAC (Direct Memory Access Controller) which controls data transfer between two components such as between the page memory and a hard disc.

In the printing apparatus, an image corresponding to a plurality of pages is printed as follows. Specifically, firstly a print process is carried out with respect to an image corresponding to Page “a”, based on image data corresponding to Page “a” stored in the page memory. Then, the page memory is initialized. After the initialization, image data of an image corresponding to Page “b” which is to be printed after Page “a” is written into the page memory.

The initialization of the page memory is carried out by writing initialization data (data “0”) into the page memory. In Patent Document 1 below, an initialization is carried out such that a DMAC writes initialization data into a page memory. This allows a reduction in processing burden of the CPU.

### [Patent Document 1]

Japanese Unexamined Patent Application Publication, Tokukaihei, No. 2-105242 (published on Apr. 17, 1990)

In recent years, an improvement in image resolution has led to an increase in the amount of image data per page. As such, the capacity of a page memory tends to increase. This causes a necessity of carrying out a faster initialization with respect to a page memory than a conventional initialization so that a print process is not delayed. In the arrangement in Patent Document 1, however, the initialization data is written into the page memory only by the DMAC. As such, a faster initialization process needs an increase of the number of DMACs. This leads to an increase in cost.

### SUMMARY OF THE INVENTION

The present invention has been made in view of the foregoing problems, and one of its objects is to provide an image processing apparatus being capable of carrying out a faster initialization process with respect to a memory without causing an increase in cost.

The initialization process carried out with respect to a memory is a process of writing initialization data into the memory. Therefore, any device transmitting data to the memory, that is to say, any device capable of writing data into the memory could carry out the initialization process with respect to the memory. For example, an image processing section, which carries out an image process with respect to image data, writes image data into a memory. Therefore, the image processing section could carry out an initialization process with respect to the memory.

Here, in order to attain the object, an image processing apparatus in accordance with the present invention includes: a transfer processing section that transfers image data to a memory; a plurality of image processing sections that carries out an image process with respect to image data, and writes, into the memory, the image data that has been subjected to the image process; and a control section that controls the transfer processing section and the plurality of image processing sections, the control section including: a selecting section that selects two or more processing sections from among the transfer processing section and the plurality of image processing sections; and an initialization control section that causes the processing sections selected by the selecting section to carry out an initialization process with respect to the memory.

In the image processing apparatus of the present invention, the initialization process with respect to the memory is not carried out by the transfer processing section alone, but is carried out by the two or more processing sections selected from among the transfer processing section and the plurality of image processing sections. Thus, the plurality of processing sections carries out the initialization process, thereby making it possible to carry out the initialization process at a higher speed, compared to the arrangement of Patent Document 1 in which only one transfer processing section (only a DMAC) carries out the initialization process. Furthermore, the image processing sections are devices generally existing in the image processing apparatus. Accordingly, it is possible to carry out the initialization process with the use of two or more processing sections, without an additional new image processing section. The arrangement of the present invention causes no increase in cost. Thus, according to an image processing apparatus of the present invention, it is possible to carry out the initialization process with respect to the memory at a high speed, without causing an increase in cost.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram showing an integrated control device, which is one embodiment of an image processing apparatus in accordance with the present invention, and a multifunction peripheral including the integrated control device.

FIG. 2 is a schematic view showing the detail of a memory unit illustrated in FIG. 1.

FIG. 3 is an explanatory diagram showing how an initialization process is carried out by a DMAC illustrated in FIG. 1.

FIG. 4 is an explanatory diagram showing how an initialization process is carried out by a first compression/extension device illustrated in FIG. 1.

FIG. 5 is an explanatory diagram showing how an initialization process is carried out by a rotation device illustrated in FIG. 1.

FIG. 6 is an explanatory diagram showing how an initialization process is carried out by a data conversion device illustrated in FIG. 1.

### DESCRIPTION OF THE EMBODIMENTS

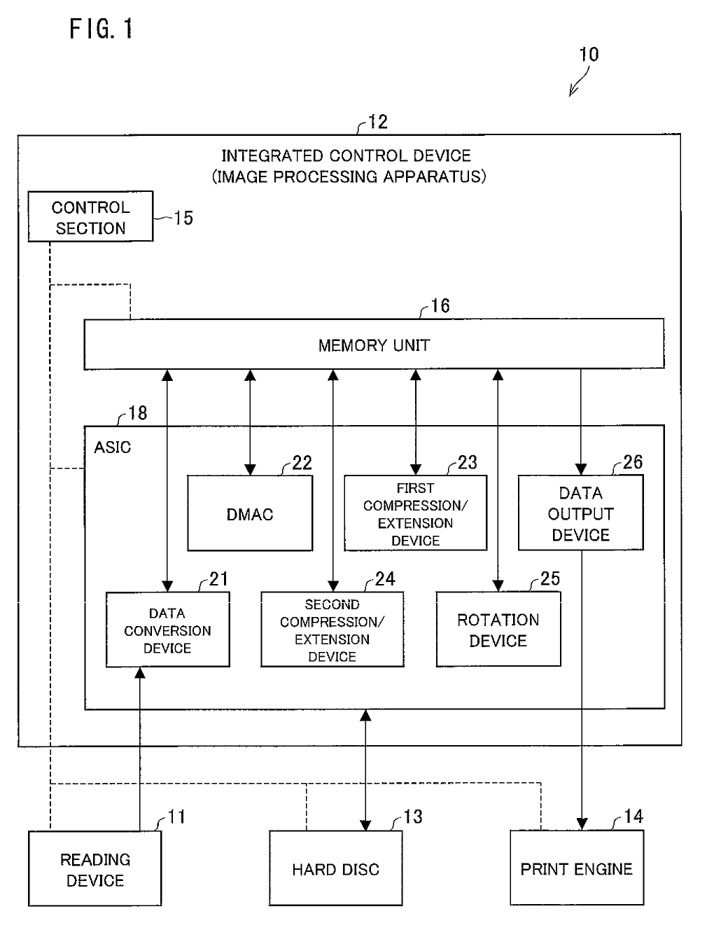

The following describes one embodiment of the present invention with reference to the drawings. FIG. 1 is a block diagram showing (i) an integrated control device 12, which is one embodiment of an image processing apparatus of the present invention and (ii) a multifunction peripheral (printing apparatus) 10 including the integrated control device 12.

The multifunction peripheral (MFP: Multi Function Printer) 10 includes, as shown in FIG. 1, a reading device 11, the integrated control device 12, a hard disc 13, and a print engine 14, and is a multifunctional apparatus which can carry out processes such as a copy process, a print process, and/or a scan process.

The copy process is a process causing the print engine 14 to print an image which is in accordance with image data scanned by the reading device 11. The print process is a process causing the print engine 14 to print an image which is in accordance with image data supplied from a terminal device (not illustrated). The scan process is a process causing the reading device 11 to scan image data and store the image data in the hard disc 13.

The reading device 11 is a scanner scanning image data from an image on a document placed on a scanner platen (not illustrated), and the reading device 11 transfers, to the integrated control device 12, the image data thus scanned. The integrated control device 12 has a function of comprehensively controlling operations of various types of hardware included in the multifunction peripheral 10. In the present embodiment, the integrated control device 12 further has a function of carrying out an image process with respect to image data and a function of transferring image data. The hard disc 13 is a storage device in which various kinds of data processed in the multifunction peripheral 10 is stored. The print engine 14 prints an image on a sheet in accordance with image data supplied from the integrated control device 12.

The following description deals with the detail of the integrated control device (image processing apparatus) 12. The integrated control device 12 includes, as shown in FIG. 1, a control section 15, a memory unit 16, and an ASIC (Application Specific Integrated Circuit) 18.

The control section 15 is a computer supplying a command to each piece of hardware included in the multifunction peripheral 10 so as to control the operation of each peace of the hardware. Specifically, the control section 15 executes a control program so as to carry out the control of the operation. The control section 15 further includes a function of carrying out, with respect to image data loaded on the memory unit 16, an image process which is in accordance with software.

The ASIC 18 has: (a) a function of carrying out, with respect to image data written in the memory unit 16, an image process which is in accordance with hardware; and (b) functions of transferring and writing, into the memory unit 16, image data which is supplied from the reading device 11, the hard disc 13 and a terminal device (not illustrated), and of supplying image data written in the memory unit 16 to the print engine 14 and the hard disc 13.

In the scan process, the ASIC 18 writes into the memory unit 16 image data supplied from the reading device 11, carries out a necessary image process with respect to the image data, and then transfers the image data from the memory unit 16 to the hard disc 13. In the copy process, the ASIC 18 writes into the memory unit 16 image data supplied from the reading device 11, carries out a necessary image process with respect to the image data, and then transfers the image data from the memory unit 16 to the print engine 14. In the print process, the ASIC 18 writes into the memory unit 16 image data supplied from an external terminal device (not illustrated), carries out a necessary image process with respect to the image data, and then transfers the image data from the memory unit 16 to the print engine 14.

The memory unit 16 is a RAM (Random Access Memory) into which image data that is subjected to an image process by the ASIC 18 is temporarily written. The detail of the memory unit 16 is described below. The memory unit 16 is a unit including a plurality of page memories (memories) into each of which image data of an image corresponding to one page is written.

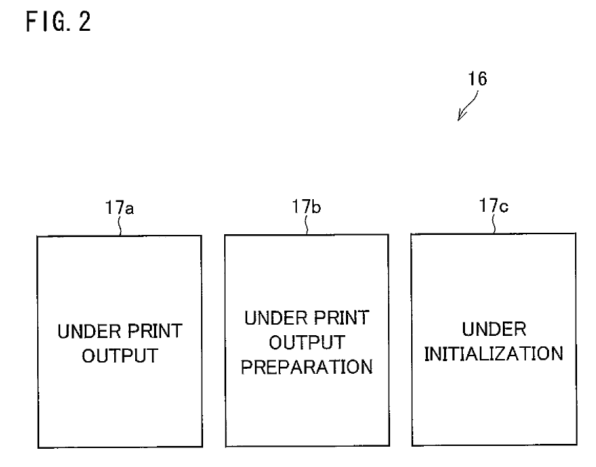

Specifically, the memory unit 16 includes, as shown in FIG. 2, a page memory 17a, a page memory 17b, and a page memory 17c. Image data corresponding to one page is written into each of the page memories (memories) 17. As such, image data corresponding to at most three pages can be simultaneously written into the memory unit 16.

In FIG. 2, image data which is being supplied to the print engine 14 is written into the page memory 17a. Image data which is to be supplied to the print engine 14 following the image data in the page memory 17a is written into the page memory 17b. Image data which was supplied to the print engine 14 before the image data in the page memory 17a is written into the page memory 17c, and the page memory 17c is under an initialization process.

When (i) all pieces of the image data in the page memory 17a are supplied to the print engine 14 and (ii) the initialization process completes with respect to the page memory 17c, the following will occur: The image data in the page memory 17b starts to be supplied to the print engine 14; image data on a page following the image data of the page memory 17b starts to be written into the page memory 17c; and the initialization process starts to be carried out with respect to the page memory 17a.

That is, in the page memory 17a, the page memory 17b, and the page memory 17c shown in FIG. 2, writing of image data, transfer of image data to a transfer destination (print engine 14), and an initialization process are subsequently carried out.

In the arrangement, before the image data written in the page memory 17 is supplied to the print engine 14, the following is carried out: The image data is supplied to each piece of hardware included in the ASIC 18, the hardware carries out an image process with respect to the image data, and then the image data is overwritten into the page memory 17.

Further, the page memories 17a through 17c in FIG. 2 are used in a copy process. A page memory (not illustrated) used in a print process and a page memory (not illustrated) used in a scan process are also included in the memory unit 16.

Next, the ASIC 18 is described. The ASIC 18 includes, as shown in FIG. 1, a data conversion device 21, a DMAC (Direct Memory Access Controller) 22, a first compression/extension device 23, a second compression/extension device 24, a rotation device 25, and a data output device 26.

The data conversion device (image processing section, data conversion section) 21 carries out the following process in a copy process: The data conversion device 21 carries out a predetermined image process with respect to image data received from the reading device 11 in order to convert the image data into image data for printing-use, and writes into the memory unit 16 the image data thus converted.

The DMAC (transfer processing section) 22 is a data transfer device for controlling data transfer between external hardware, such as the hard disc 13 and the reading device 11, of the integrated control device 12 and the memory unit 16, in accordance with a command from the control section 15. Specifically, the DMAC 22 controls a process for reading out image data written in the hardware of a transfer source, and for writing, into the hardware of a transfer destination, the image data thus read.

For example, in the foregoing scan process, the image data scanned by the reading device 11 (i) is temporarily written into the memory unit 16, (ii) is subjected to an image process, and (iii) is then transferred to the hard disc 13. At this time, (a) the transfer process of the image data between the reading device 11 and the memory unit 16 and (b) the transfer process of the image data between the memory unit 16 and the hard disc 13 are carried out by the DMAC 22. Further, for example, when image data of Print Job “b” to be executed following Print Job “a” is supplied from a terminal device to the multifunction peripheral 10 while a print process corresponding to Print Job “a” is executed in the multifunction peripheral 10, the image data of Print Job “b” is temporarily stored in the hard disc 13 and is transferred from the hard disc 13 to the memory unit 16 after the image data of Print Job “a” is deleted from the memory unit 16. In this case, the transfer process of the image data from the hard disc 13 to the memory unit 16 is carried out by the DMAC 22.

The first compression/extension device (image processing section, extension processing section) 23 is a device for carrying out, in response to a command from the control section 15, a compression/extension process with respect to image data written in the memory unit 16, which compression/extension process is in accordance with an MH (Modified Huffman) method, an MR (Modified Read) method, or an MMR (Modified Modified Read) method. The second compression/extension device (image processing section, extension processing section) 24 is a device for carrying out, in response to a command from the control section 15, a compression/extension process with respect to image data written in the memory unit 16, which compression/extension process is in accordance with a JBIG (Joint Bi-level Image experts Group) method or a JPEG (Joint Photographic Experts Group) method.

Specifically, the first or second compression/extension device 23 or 24 receives image data written in the memory unit 16, carries out a compression/extension process with respect to the image data thus received, and overwrites the image data which has been subjected to the compression/extension into the memory unit 16.

In the foregoing scan process, the first or second compression/extension device 23 or 24 carries out a compression process with respect to image data which is scanned by the reading device 11 and is written in the memory unit 16. Then, the image data thus compressed is supplied by the DMAC 22 to the hard disc 13 so as to be stored in the hard disc 13.

In the foregoing print process, image data supplied from a terminal device (not illustrated) is the one that has been subjected to the compression process. The image data is temporarily written into the memory unit 16, and is then extended by the first or second compression/extension device 23 or 24.

Further, image data stored in the hard disc 13 is the one that has been subjected to the compression process. When the image data is read out by the DMAC 22 from the hard disc 13 and is then written into the memory unit 16, the first or second compression/extension device 23 or 24 carries out an extension process with respect to the image data written in the memory unit 16.

The rotation device (image processing section, rotation processing section) 25 is a device for carrying out, in response to a command from the control section 15, a rotation process with respect to image data written in the memory unit 16. The rotation process means here a rotation process: made, using a buffer for rotation-use, in hardware manner, by which rotation process image data is rotated by 0 degree, 90 degrees, 180 degrees, or 270 degrees.

For example, in case where a 90-degree rotation process is carried out, the rotation device 25 reads out, in sequence, image data written in the memory unit 16 in a perpendicular direction of the image, and writes, in sequence the image data thus read out, into the buffer for rotation-use in a horizontal direction of the image. Then, the rotation device 25 overwrites into the memory unit 16 the image data stored in the buffer so that the direction in which the image data is read out from the buffer and the direction in which the image data is written into the memory unit 16 coincide with each other. As a result, the image data to be overwritten into the memory unit 16 is prepared by rotating, by 90 degrees, the image data which has been written in the memory unit 16 before the overwriting process is carried out.

The data output device 26 is a device that transfers image data to the print engine 14 in response to a command from the control section 15, after an image process is carried out by the hardware in the ASIC 18 with respect to the image data written in the memory unit 16.

Note in the present embodiment that, in a case of carrying out an initialization process on each of the page memories 17 provided in the memory unit 16, the initialization process is carried out not only by the DMAC 22, but also by the image processing section (the first compression/extension device 23, the second compression/extension device 24, the rotation device 25, and the data conversion device 21) provided in the ASIC 18. Note that (i) the initialization process, fundamentally, is a process for writing initialization data (data “0”) into the page memory 17 and (ii) such a process may be carried out not only by the DMAC 22, but also by each of the image processing sections provided in the ASIC 18. In view of this, the present embodiment intends to realize a fast initialization process by involving the DMAC 22 and at least one of the image processing sections in the initialization process.

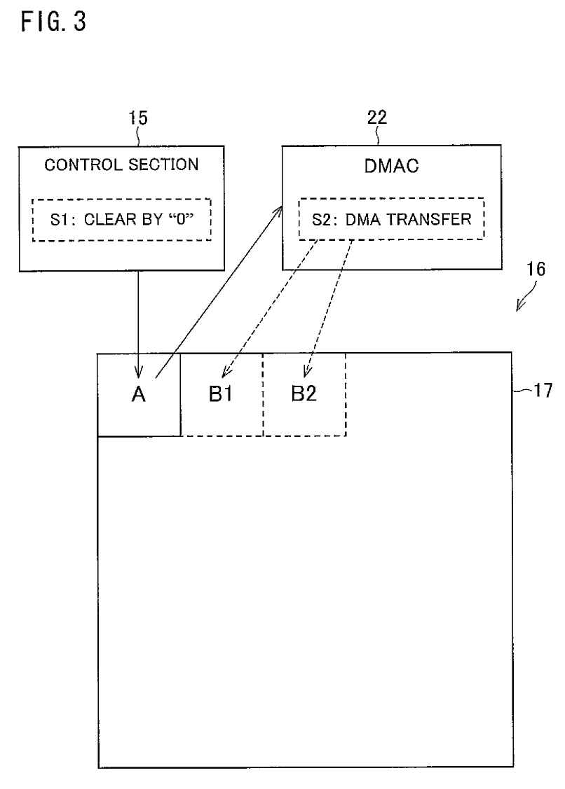

The following description deals with in detail an initialization process of the present embodiment. Firstly, an initialization process carried out by the DMAC 22 is described. FIG. 3 is an explanatory diagram showing how the initialization is carried out by the DMAC 22.

As shown in FIG. 3, firstly, the control section 15 writes data “0” into Region “A”, which is a part of the page memory 17 (S1). Next, upon receipt of an initialization command from the control section 15, the DMAC 22 reads out the data “0” from Region “A” in response to the initialization command, and then transfers and writes the data “0” into Region “B1” (S2). Region “B1” is a part of the page memory 17, and data “0” has not been written into Region “B1” before the process “S2” is carried out. Then, the DMAC 22 changes the transfer destination of the data “0” to other regions (Region “B2”, Region “B3”, Region “B4”, . . . ) where data “0” is not written, and repeats the process “S2”. This causes an enlargement of regions on the page memory 17 where data “0” is written, thereby initializing the page memory 17.

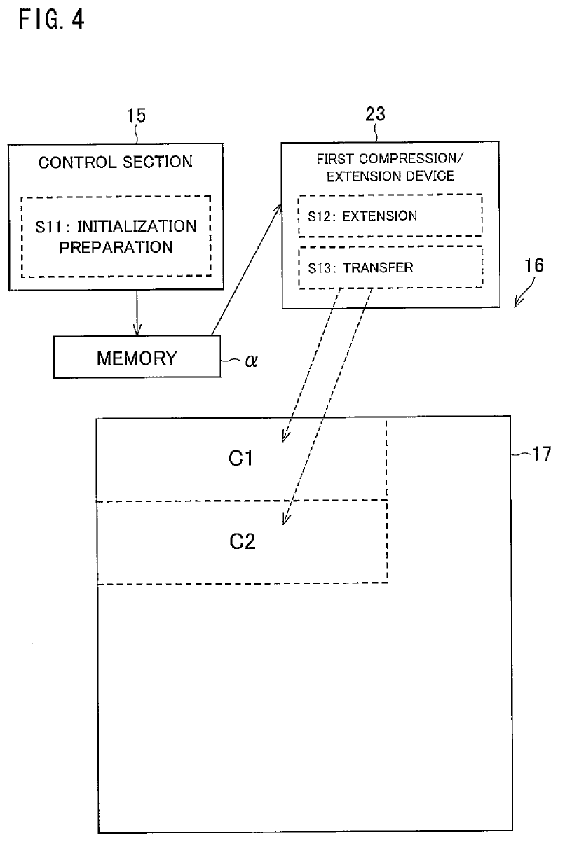

Next, an initialization process carried out by the first compression/extension device 23 is described. FIG. 4 is an explanatory diagram showing how the initialization process is carried out by the first compression/extension device 23.

As shown in FIG. 4, firstly, the control section 15 writes pre-initialization data into Memory α which is not the page memory 17 (S11). The process “S11” is a preparation for an initialization process. When pre-initialization data is subjected to an extension process, the pre-initialization data becomes data “0”.

Next, upon receipt of an initialization command from the control section 15, the first compression/extension device 23 reads out the pre-initialization data from Memory α in response to the initialization command, and extends the pre-initialization data thus read out so as to prepare data “0” (S12). For example, in the case of the MMR method, the pre-initialization data is 0xFF, and 0xFF is extended to prepare data “0”.

Then, the first compression/extension device 23 transfers and writes into Region “C1” the data “0” obtained by extending the pre-initialization data (S13). Region “C1” is a part of the page memory 17 and data “0” has not been written into Region “C1” before the process “S13” is carried out. After that, the first compression/extension device 23 changes the transfer destination of the data “0” to other regions (Region “C2”, Region “C3”, Region “C4”, . . . ) where data “0” is not written, and then repeats the processes “S12” and “S13”. This causes an enlargement of regions on the page memory 17 where data “0” is written, thereby initializing the page memory 17.

According to the procedure shown in FIG. 4, the extension process is carried out by the first compression/extension device 23 with respect to data “0”, before the data “0” is written into Region “C1” and other Regions. On the other hand, in the procedure shown in FIG. 3, the data “0” in Region “A” is not extended before the data “0” is written into Region “B1” (the data “0” is, as it is, written into Region “B1”) and other Regions. On this account, a faster process is carried out in FIG. 4 than in FIG. 3.

The second compression/extension device 24 can also carry out an initialization process. The procedure for the initialization process carried out by the second compression/extension device 24 is substantially the same as that for the initialization process carried out by the first compression/extension device 23 as described with reference to FIG. 4. As such, the description for the procedure for the initialization process carried out by the second compression/extension device 24 is omitted here.

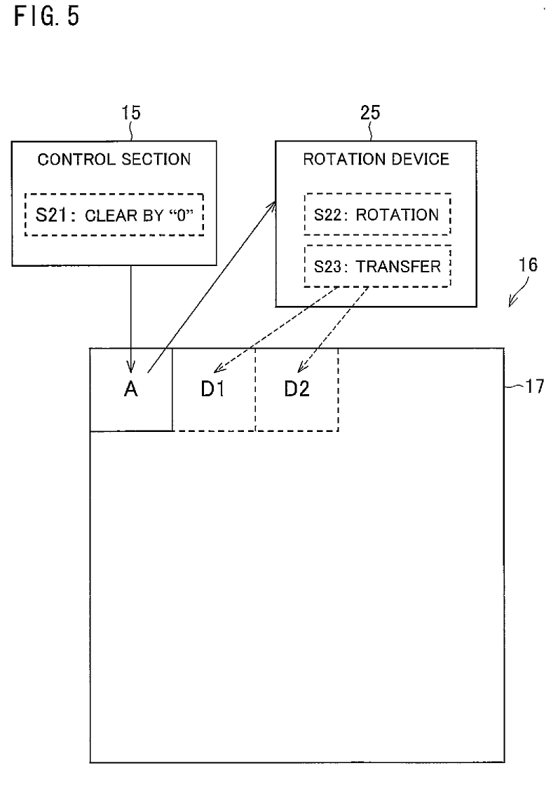

Next, an initialization process carried out by the rotation device 25 is described. FIG. 5 is an explanatory diagram showing how the initialization process is carried out by the rotation device 25.

As shown in FIG. 5, firstly, the control section 15 writes data “0” into Region “A”, which is a part of the page memory 17 (S21). Next, upon receipt of an initialization command from the control section 15, the rotation device 25 reads out the data “0” from Region “A” in response to the initialization command, and writes the data “0” thus read out into a buffer for rotation-use, so as to carry out a rotation process with respect to the data “0” (S22). Then, the rotation device 25 transfers and writes into Region “D1” the data “0” that has been subjected to the rotation process (S23). Region “D1” is a part of the page memory 17 and data “0” has not been written into Region “D1” before the process “S23” is carried out. After that, the rotation device 25 changes the transfer destination of the data “0” to other regions (Region “D2”, Region “D3”, Region “D4”, . . . ) where data “0” is not written, and repeats the processes “S22” and “S23”. This causes an enlargement of regions on the page memory 17 where data “0” is written, thereby initializing the page memory 17. In the procedure in FIG. 5, the degree of the rotation process may be 0 degree, 90 degrees, 180 degrees, or 270 degrees.

Next, prior to the description for an initialization process carried out by the data conversion device 21, the description is made as to an invalidation process carried out by the data conversion device 21 when a copy process is carried out.

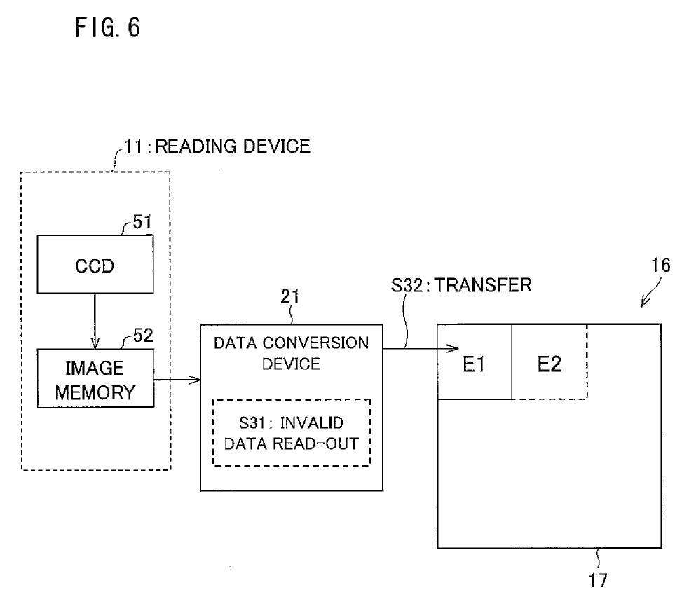

As shown in FIG. 6, in a copy process, image data scanned by a CCD (Charge Coupled Device) 51 in the reading device 11 is temporarily written into an image memory 52 in the reading device 11, and is then transferred to the data conversion device 21. The data conversion device 21 carries out various kinds of image processes so as to convert, into image data for printing-use, the image data thus received. In addition, the data conversion device 21 carries out an invalidation process with respect to unnecessary data contained in the image data.

The following description further deals with in detail the invalidation process. While the CCD 51 scans an image on a document, the CCD 51 necessarily scans the image including not only a copying part to be copied but also a non-copying part not to be copied, the non-copying part being a part around the copying part. In this regard, the data conversion device 21 recognizes as unnecessary data the image data of the non-copying part contained in the image data received from the image memory 52, and carries out an invalidation process with respect to the unnecessary data, in which invalidation process the unnecessary data is converted into invalid data (data “0”). This causes, in a subsequent print process, (i) the non-copying part not to be copied (printed) and (ii) the copying part to be copied (printed).

The following description deals with an initialization process carried out by the data conversion device 21. Upon receipt an initialization command from the control section 15, the data conversion device 21 reads out invalid data, which is fundamentally used in the invalidation process, in response to the initialization command as shown in FIG. 6 (S31). Then, the data conversion device 21 transfers and writes the invalid data into Region “E1”, which is a part of the page memory 17 (S32). After that, the data conversion device 21 changes the transfer destination of the invalid data to other regions (Region “E2”, Region “E3”, Region “E4”, . . . ) where data “0” is not written, and repeats the process “S32”. This causes an enlargement of regions on the page memory 17 where data “0” is written, thereby initializing the page memory 17.

As described above, according to the present embodiment, not only the control section 15 and the DMAC 22, but also the image processing sections such as the data conversion device 21, the first compression/extension device 23, the second compression/extension device 24, and the rotation device 25 can carry out an initialization process (i.e., writing data “0”) with respect to the page memory 17 provided in the memory unit 16.

Therefore, according to the present embodiment, when the necessity for initializing the page memory 17 arises, the control section 15 selects two or more devices out of the group consisting of the DMAC 22, the data conversion device 21, the first compression/extension device 23, the second compression/extension device 24, and the rotation device 25, and provides an initialization command to the devices thus selected, respectively. This causes the selected devices to simultaneously carry out an initialization process with respect to the page memory 17. For example, when the DMAC 22 and the rotation device 25 are selected, the DMAC 22 and the rotation device 25 carry out an initialization process simultaneously and collaterally.

That is, the control section 15 functions as a selecting section for selecting two or more processing sections out of the transfer processing section (the DMAC 22) and image processing sections (the data conversion device 21, the first compression/extension device 23, the second compression/extension device 24, and the rotation device 25). The control section 15 functions as an initialization control section for causing selected processing sections to carry out an initialization process with respect to the page memory 17.

This causes a plurality of processing sections to carry out the initialization process. A faster initialization process can be carried out in the present arrangement than in the arrangement disclosed in Patent Document 1 where only one processing section (only the DMAC) carries out the initialization process. In addition, the image processing sections such as the data conversion device 21, the first compression/extension device 23, the second compression/extension device 24, and the rotation device 25 are devices generally existing in the integrated control device 12. Accordingly, it is possible to carry out the initialization process by using two or more processing sections as described in the present embodiment, without an additional new image processing section. This causes no increase in cost. For this reason, according to the arrangement of the present embodiment, it is possible to carry out a fast initialization process with respect to the memory, without causing an increase in cost.

Furthermore, each of the DMAC 22, the first compression/extension device 23, the second compression/extension device 24, and the rotation device 25 is a circuit having a function for reading out data written in the page memory 17 and a function for writing data into the page memory 17. The control section 15 firstly functions as a writing section for writing data “0” into a partial region on the page memory 17. Secondly, the control section 15 functions as a command execution section for causing the DMAC 22, the first compression/extension device 23, the second compression/extension device 24, and the rotation device 25 to execute (i) the processing of reading out data “0” from the partial region and (ii) the processing of writing the data “0” thus read out into a region on the page memory 17 where the data “0” is not written. This allows an enlargement of the regions on the page memory 17 where the data “0” is written, thereby carrying out the initialization process with respect to the page memory 17.

The data conversion device 21 carries out a process for converting into invalid data unnecessary data contained in image data scanned by the reading device 11. It is also possible to initialize the page memory 17, when the control section 15 controls the data conversion device 21 so that the data conversion device 21 writes the invalid data into the page memory 17. This is based on the fact that the invalid data has the same value (data “0”) as the value of the initialization data. As such, the writing of the invalid data into the page memory 17 achieves the same effect as the writing of the initialization data into the page memory 17. This allows the page memory 17 to be initialized.

Also, when the necessity for an initialization process arises, it is preferable for the control section 15 to select the DMAC 22 which is not under transfer operation or image processing sections (the data conversion device 21, the first compression/extension device 23, the second compression/extension device 24, and/or the rotation device 25) which is(are) not under image processing operation so that the DMAC 22 and/or the image processing section(s) thus selected carry out an initialization process. When the DMAC 22 which is under transfer operation or an image processing section which is under image processing operation is selected so that the DMAC 22 or the image processing section thus selected carries out the initialization process, the transfer operation or the image processing operation is suspended, thereby causing a delay in the processing of the entire integrated control device 12. In contrast, when the DMAC 22 which is not under transfer operation and/or the image processing section(s) which is(are) not under image processing operation are selected, it is possible to avoid that the transfer operation and/or the image processing operation are suspended, thereby suppressing an adverse effect that the processing of the entire the integrated control device 12 is delayed.

For example, when an initialization process is carried out by the DMAC 22 (a first processing section) and the first compression/extension device (a second processing section) 23 which carries out the initialization process at a higher speed than the DMAC 22, it is preferable for the control section 15 to control the DMAC 22 and the first compression/extension device 23 so that the amount of the initialization process carried out by the first compression/extension device 23 becomes greater than that carried out by the DMAC 22. As a result, a higher-performance (faster processing) device takes much amount of processing. Therefore, the higher-performance device can be effectively utilized, thereby making it possible to carry out an initialization process more effectively.

For example, when an initialization process is carried out by the DMAC 22 (the first processing section) and the first compression/extension device (the second processing section) 23 which carries out the initialization process at a higher speed than the DMAC 22, it is preferable for the control section 15 to control each amount of the initialization process carried out by the DMAC 22 and the first compression/extension device 23 so that the time required for the DMAC 22 to carry out the initialization process becomes equal to the time required for the first compression/extension device 23 to carry out the initialization process. As a result, even if the speed for the initialization process differs from device to device carrying out the initialization process, the time required for the devices to carry out the initialization process can be uniform. Therefore, it is possible to reduce the time required for carrying out the entire initialization process by causing the devices to simultaneously and concurrently carry out the initialization process.

In the initialization processes shown in FIG. 3, FIG. 4, and FIG. 5, the writing of the first data “0” into the page memory 17 (i.e., the writing of data “0” into Region “A”) is carried out by the control section 15. However, the writing of the first data “0” may be realized by a writing of invalid data which writing is carried out by the data conversion device 21.

In cases where the multifunction peripheral 10 has a facsimile function, it receives from a facsimile image data that has been compressed, and the image data is written into the memory unit 16 so as to be subjected to compression by the first or second compression/extension device 23 or 24.

The print engine 14 in FIG. 1 may be: a print engine using an electrophotographic printing method; a print engine using an inkjet method; a print engine capable of carrying out color printing; or a print engine capable of carrying out monochrome printing only.

In FIG. 1, the number of resources for each of the first compression/extension device 23 and the second compression/extension device 24 is one. Actually, however, the number of resources for each of the first compression/extension device 23 and the second compression/extension device 24 is more than one.

By the way, a function carried out by the control section 15 in FIG. 1 can be realized as follows. Specifically, an arithmetic circuit such as a processor (for example, a CPU) executes a program(s) stored in storage means such as a ROM and/or a RAM so as to control various peripheral circuits, sensors and the like. Therefore, the control section 15 of the present embodiment can be realized as follows. Specifically, a computer including the arithmetic circuit, the peripheral circuits and the like accesses storage medium storing the program(s), and executes the program(s), thereby realizing the control section 15. The storage medium may be, for example, tape such as magnetic tape or cassette tape; a disc encompassing a magnetic disc such as a floppy® disc or a hard disc, and an optical disc such as a CD-ROM, an MO, an MD, a DVD, or a CD-R; a card such as an IC card (encompassing a memory card) or an optical card; and a semiconductor memory such as a mask ROM, an EPROM, an EEPROM, or a flash ROM.

In order to attain the foregoing object, according to the present invention, in an image processing apparatus comprising: a transfer processing section that transfers image data to a memory; a plurality of image processing sections that carries out an image process with respect to image data, and writes, into the memory, the image data that has been subjected to the image process; and a control section that controls the transfer processing section and the plurality of image processing sections, the control section includes: selecting means (a selecting section) that selects two or more processing sections from among the transfer processing section and the plurality of image processing sections; and initialization control means (an initialization control section) that causes the processing sections selected by the selecting section to carry out an initialization process with respect to the memory.

The initialization process carried out with respect to the memory is a process of writing initialization data into the memory. Therefore, any device transmitting data to the memory, that is to say, any device capable of writing data into the memory could carry out the initialization process with respect to the memory. For example, an image processing section, which carries out an image process with respect to image data, writes image data into a memory. Therefore, the image processing section could carry out the initialization process with respect to the memory. According to the present invention, the initialization process with respect to the memory is not carried out by the transfer processing section alone, but is carried out by the two or more processing sections selected from among the transfer processing section and the plurality of image processing sections. Thus, the plurality of processing sections carries out the initialization process, thereby making it possible to carry out the initialization process at a higher speed, compared to the arrangement described in Patent Document 1 in which only one transfer processing section (only a DMAC) carries out the initialization process. Furthermore, because the image processing sections are devices generally existing in the image processing apparatus, it is possible to carry out the initialization process with the use of two or more processing sections as in the present invention. The arrangement of the present invention causes no increase in cost. Thus, according to the arrangement of the present invention, it is possible to carry out an initialization process with respect to a memory at a high speed, without causing an increase in cost.

In the image processing apparatus of the present invention, when each of the transfer processing section and the image processing section is a circuit having a function for reading out data written in the memory and a function for writing data into the memory, the initialization control section may be designed as follows so as to carry out an initialization process: Firstly, the initialization control section functions as writing means (a writing section) for writing initialization data into a partial region on the memory; Secondly, the initialization control section functions as command execution means (a command execution section) for causing the processing sections selected by the selecting means to execute (i) the processing of reading out the initialization data from the partial region and (ii) the processing of writing the initialization data thus read out into a region on the memory where the initialization data is not written. This allows an enlargement of the regions on the memory where the initialization data is written, thereby carrying out the initialization process with respect to the memory.

In the image processing apparatus of the present invention, the transfer processing section may be a DMAC. Also, in the image processing apparatus of the present invention, at least one of the plurality of image processing sections may be a rotation processing section that carries out a rotation process with respect to image data. Further, in the image processing apparatus of the present invention, at least one of the plurality of image processing sections may be an extension processing section that carries out an extension process on image data.

Also, the image processing apparatus of the present invention may be arranged as such that at least one of the plurality of the image processing sections is a data conversion section which carries out a process for converting unnecessary data contained in image data into invalid data having the same value as that of the initialization data, and the initialization control section causes the data conversion section to write the invalid data into the memory. When the invalid data is written into the memory by the data conversion section as in this arrangement, the same effect can be achieved as when initialization data is written into the memory. This makes it possible to initialize the memory.

Further, the image processing apparatus of the present invention is preferably arranged such that said two or more processing sections selected by the selecting section are not under transfer operation or not under image processing operation. When the transfer processing section which is under transfer operation or an image processing section which is under image processing operation is selected so that the processing section thus selected carries out an initialization process, the transfer operation or the image processing operation is suspended, thereby causing a delay in the processing of the entire image processing apparatus. With the foregoing arrangement, however, it is possible to avoid that the transfer operation and/or the image processing operation are suspended, thereby suppressing an adverse effect that the processing of the entire image processing apparatus is delayed.

In addition, when the processing section selected by the selecting section includes a first processing section and a second processing section, the second processing section carrying out an initialization process at a higher speed than the first processing section, the initialization control section is preferably arranged such that the initialization control section controls the first and second processing sections so that the second processing section carries out the initialization process more than the first processing section. As a result, a higher-performance (faster-processing) processing section takes much amount of processing. Therefore, the higher-performance processing section can be effectively utilized, thereby making it possible to carry out the initialization process more effectively.

Also, the initialization control section is preferably arranged such that the initialization control section controls each amount of the initialization process carried out by the first processing section and the second processing section so that time required for the first processing section to carry out the initialization process becomes equal to the time required for the second processing section to carry out the initialization process. As a result, even if the speed for the initialization process differs from processing section to processing section selected by the selecting section, the time required for the processing sections to carry out the initialization process can be uniform. Therefore, it is possible to reduce the time required for carrying out the initialization process by causing the processing sections to simultaneously and concurrently to carry out the initialization process.

The above-described image processing apparatus may be provided in a printing apparatus. In this specification, the printing apparatus means a multifunction peripheral, a copying machine, a printer, or a facsimile.

The control section included in the image processing apparatus of the present invention may be realized by a computer. In this case, the scope of the present invention covers (i) a control program causing the computer to operate as the control section and (ii) a computer-readable storage medium storing the control program.

The image processing apparatus of the present invention is suitable for a printing apparatus such as a multifunction peripheral, a copying machine, a printer, or a facsimile. However, the present invention is not limited to these, and may be extensively applicable to a scanner and other apparatuses.

The present invention is not limited to the foregoing embodiments, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An image processing apparatus, comprising:
a transfer processing section that transfers image data to a memory;
a plurality of image processing sections that carries out an image process with respect to image data, and writes, into the memory, the image data that has been subjected to the image process; and
a control section that controls the transfer processing section and the plurality of image processing sections,
the control section including:
a selecting section that selects two or more processing sections from among the transfer processing section and the plurality of image processing sections; and
an initialization control section that causes the processing sections selected by the selecting section to carry out an initialization process with respect to the memory.

2. The image processing apparatus as set forth in claim 1,
wherein each of the transfer processing section and the image processing sections is a circuit having a function for reading out data written in the memory and a function for writing data into the memory, and
the initialization control section includes:
a writing section that writes initialization data into a partial region on the memory; and
a command execution section that causes the processing sections selected by the selecting section to carry out a process of reading initialization data from the partial region, and a process of writing the initialization data into a region on the memory where initialization data is not written.

3. The image processing apparatus as set forth in claim 1, wherein the transfer processing section is a direct memory access controller.

4. The image processing apparatus as set forth in claim 1, wherein at least one of the plurality of image processing sections is a rotation processing section that carries out a rotation process with respect to image data.

5. The image processing apparatus as set forth in claim 1, wherein at least one of the plurality of image processing sections is an extension processing section that carries out an extension process with respect to image data.

6. The image processing apparatus as set forth in claim 1,
wherein at least one of the plurality of image processing sections is a data conversion section which carries out a process for converting unnecessary data contained in image data into invalid data having the same value as that of the initialization data, and
the initialization control section causes the data conversion section to write the invalid data into the memory.

7. The image processing apparatus as set forth in claim 1, wherein said two or more processing sections selected by the selecting section are not under transfer operation or not under image processing operation.

8. The image processing apparatus as set forth in claim 1, wherein the processing sections selected by the selecting section are a first processing section and a second processing section, the second processing section carrying out an initialization process at a higher speed than the first processing section, and
the initialization control section controls the first and second processing sections so that the second processing section carries out the initialization process more than the first processing section.

9. The image processing apparatus as set forth in claim 8, wherein the initialization control section controls each amount of the initialization process carried out by the first processing section and the second processing section so that time required for the first processing section to carry out the initialization process becomes equal to time required for the second processing section to carry out the initialization process.

10. An image processing apparatus, comprising:
a transfer processing section that transfers image data to a memory;
a plurality of image processing sections that carries out an image process with respect to image data, and writes, into the memory, the image data that has been subjected to the image process; and
a control section that controls the transfer processing section and the plurality of image processing sections,
the control section causing two or more processing sections of the transfer processing section and the plurality of image processing sections to carry out an initialization process with respect to the memory.

11. A printing apparatus comprising an image processing apparatus, the image processing apparatus including:
a transfer processing section that transfers image data to a memory;
a plurality of image processing sections that caries out an image process with respect to image data, and writes, into the memory, the image data that has been subjected to the image process; and
a control section that controls the transfer processing section and the plurality of image processing sections,
the control section including:
a selecting section that selects two or more processing sections from among the transfer processing section and the plurality of image processing sections; and
an initialization control section that causes the processing sections selected by the selecting section to carry out an initialization process with respect to the memory.

12. A control program for causing an image processing apparatus to be controlled, the image processing apparatus comprising:
a transfer processing section that transfers image data to a memory;
a plurality of image processing sections that carries out an image process with respect to image data, and writes, into the memory, the image data that has been subjected to the image process; and
a control section that controls the transfer processing section and the plurality of image processing sections,
the control program for causing the control section to carry out:
a selecting process for selecting two or more processing sections from among the transfer processing section and the plurality of image processing sections; and
an initialization control process for causing the processing sections selected by the selecting section to carry out an initialization process with respect to the memory.
